(19) United States
(12) Patent Application Publication
(10) Pub. No.: US 2009/0286072 A1
(43) Pub. Date: Nov. 19, 2009

(54) CONTROL ELEMENT WITH A METALLIC COATING FOR A MOTOR VEHICLE

(76) Inventors: Wolfgang Küchler, Ostheim (DE); Matthias Lust, Bad Neustadt (DE)

Correspondence Address: Muncy, Geissler, Olds & Lowe, PLLC, P.O. BOX 1364, FAIRFAX, VA, 22038-1364, US

(21) Appl. No.: 12/471,964

(22) Filed: May 26, 2009

Related U.S. Application Data
(63) Continuation of application No. PCT/EP2007/010204, filed on Nov. 23, 2007.

(30) Foreign Application Priority Data
Nov. 24, 2006 (DE) 10 2006 055 971.1

(51) Int. Cl. B32B 33/00; B32B 9/00

(52) U.S. Cl. 428/336; 428/411.1

(57) ABSTRACT

A control element is provided that includes a plastic base body and a coating that is applied to the entire surface of the plastic base body facing the control element and that can be transilluminated. The coating, which can be a metallic coating, can be applied by a PVD method and can be applied directly and uniformly to the plastic base body and can have a layer thickness of between 5 nm and 100 nm.

This nonprovisional application is a continuation of International Application No. PCT/EP2007/010204, which was filed on Nov. 23, 2007, and which claims priority to German Patent Application No. DE 10 2006 055 971.1, which was filed in Germany on Nov. 24, 2006, and which are both herein incorporated by reference.

### BACKGROUND OF THE INVENTION

1. Field of the Invention

The invention relates to a control element for a motor vehicle having at least one plastic base body and a coating, such as a metallic coating, applied to substantially the entire surface of the plastic base body and adapted to be transilluminated. The metallic coating can be applied by a PVD method.

2. Description of the Background Art

In order to control various settings in a motor vehicle, such as an indoor temperature or a navigation system, control dials, push buttons, switches or comparable input assistances are provided in the motor vehicle. The automotive industry aims at adapting the control elements to the interior trim so as to provide for a high-quality and metallic aesthetic appearance without being directly made from metal. On the one hand, the metallic appearance serves to contribute to the high-quality appearance of the control elements and on the other hand, the metallic coating gives the user a tactile feeling to actuate metallic control elements.

Since in modern motor vehicles the number of control elements in the form of push switches, push buttons, rockers, rotary switches or combined push and rotary dials has greatly increased, it is another objective of the automotive industry to only show the functions to be controlled by the control elements when these are available provided that a function has been chosen. If these functions of the control elements cannot be selected, no symbol is displayed in this control element. This technique is also referred to as the disappearance technique. If, by contrast, the function of the control element is available, the control element is back lighted so that a symbol and/or lettering provided in the control element are displayed. If the control element is a push button by means of which the opening and closing of a convertible top is controlled this push button is operable and, as a result thereof, back lighted when the motor vehicle is at standstill so that the operator is capable of opening and closing the convertible top. During the ride, this function is not available to the operator so that the function symbol is not displayed. As a result, increased control security in the motor vehicle may thus be achieved.

A control system with control elements that may be blacked out and in which the control elements have an almost uniform color adapted to the surface of the control element is described in DE 103 41 623 B3. The control system includes function symbols that are adapted to be transilluminated, the region of the function symbol adapted to be transilluminated being provided with an electrochromic layer so that the function symbol can be blacked out.

The document DE 10 2005 006 459, which corresponds to U.S. Publication No. 20080063836, and which is incorporated herein by reference, shows how to apply metallic coatings onto plastic component parts having a display region. The metallized plastic component part, which is in particular a control element for a motor vehicle, is provided with a metallic top coating by a PVD method so that the plastic component part is given a metallic appearance and a metallic haptic sensation.

Generic prior art is disclosed in the document DE 10 2005 032 717 B3. Therein there is disclosed a control unit that comprises a translucent plastic base carrier provided with a surface coating, the plastic base carrier has a first region with an opaque surface coating and a second region with a translucent surface coating and the opaque surface coating contains a visible metallic coating, the translucent surface coating contains a translucent metallic coating and the metallic coating of the translucent surface coating and the metallic coating of the opaque surface coating have different appearances. The plastic base carrier is at first completely provided with a lacquer layer that is subsequently removed by a laser beam in a region showing a symbol. Next, the outer surface is provided with a metallic coating, this outer surface being understood to refer to the region provided with the lacquer layer and to the region in which the lacquer layer has been removed by laser. The metallic coating is hereby applied by a PVD method. In order to make sure that the control element can be transilluminated, the entire coating thickness of the metallic coating is so thin that light from a light source can pass through the metallic coating. Through the different surface roughness of the lacquer layer and of the region laid bare by the laser beam, the symbol is visible even when not illuminated due to different degrees of gloss of the surfaces.

### SUMMARY OF THE INVENTION

It is therefore an object of the invention to provide a control element that comprises a metallic coating and at the same time the possibility of displaying a symbol, whereby the symbol is visible when not in function according to the disappearance technique. A further object is in providing a solution which is low-cost and simple in terms of construction.

In an embodiment, a coating, such as a metallic coating is applied directly and homogeneously to the plastic base body such that it comprises a coating thickness ranging from about 5 nm to 100 nm. Through the configuration of the control element in accordance with the invention with a metallic coating being applied directly to a plastic base body, it is now possible to provide a control element that can be transilluminated by a light and has concurrently, in an non-lighted condition, the appearance of a metal coated or metallic control element. It is thus possible, in accordance with the invention, to represent a control element that comprises on the one side a surface that is free from symbols and/or pictograms and/or letterings as long as a back-lighting is not switched on and that is at the same time capable of displaying a function with the help of a pictogram and/or of a symbol and/or of a lettering. This offers on the one hand the advantage that pictograms, symbols or letterings can be displayed but also on the other hand, optionally, the advantage that they are available as control elements without a symbol.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a sectional view through a control element lacquered on a backside according to an embodiment of the invention;

FIG. 2 shows a sectional side view through an alternative control element made from different plastic materials;

FIG. 3 shows a sectional side view through an alternative control element in which there is inserted a foil; and

FIG. 4 shows a sectional side view through another alternative control element in which there is inserted a foil.

### DETAILED DESCRIPTION

In FIG. 1 there is shown a sectional side view of a control element 1. A plastic base body 2 is provided on an inner side 3 with an opaque lacquer layer 4. On the entire or a portion of the entire outer surface 5 of the plastic base body there is applied a metallic coating 6, which can include the entire outer surface 5 of the control element 1. For simplicity's sake, only surface 5, which is turned toward an operator, is shown with a coating 6 in FIG. 1. A clear lacquer layer 7 can be applied on top of the metallic coating 6.

In the opaque lacquer layer 4 there can be provided a symbol and/or a pictogram and/or a lettering 8. This symbol 8 may, for example, be placed into the lacquer layer 4 by a laser or the lacquer layer 4 is applied through a stencil placed onto an inner side of the plastic base body 2 so that the symbol region 8 remains free of lacquer. The lacquer layer 4 can be made from an opaque material so that a light L generated by a lighting device 9 is only visible through the symbol regions 8.

The plastic base body 2 can be made from a transparent or colored material such as polycarbonate (PC) or polymethylmethacrylate (PMMA). In accordance with an embodiment of the invention, the plastic base body 2 can be a push button, a control dial, a rocker or a multifunction input control element. The plastic base body 2 can also be a rotary button for so-called white goods or for electronic equipment of entertainment electronics. Beside the implementation of the plastic base body as a control element 1, the invention may also be used for regions that may only be transilluminated visually such as corona lighting or display bars or display symbols in a control element 1 of an air conditioning system of a motor vehicle for example. In this example embodiment, the plastic base body is lacquered on its inner side 3 and is metal-coated on the outer side 5 and can be transilluminated by the lighting device 9.

On the outer surface 5 of the plastic base body there can be applied a metallic coating 6 which gives the plastic base body a metallic appearance. By homogeneously applying this coating directly on a portion or on substantially the entire surface of the plastic base body 2 a uniform unitary surface 5 is generated on the control element 1, which translates into a pleasant haptic sensation and makes an optically qualitative impression. If in FIG. 1 the metallic coating 6 is only applied on one side of the plastic base body, it should be understood that a metallic coating 6 can be applied to the entire surface 5 of the plastic base body 2. In order to achieve sufficient capacity of transillumination and of displaying a symbol 8 on the control element 1, the metallic coating 6 can be applied on the plastic base body 2 in a coating thickness range from about 5 nm to 100 nm. This ensures on the one hand that the plastic base body 2 is completely covered, meaning that the material of the plastic base body is no longer visible and that a metallic optical appearance is thus achieved on the other hand.

To even further improve the optical aesthetics of the control element and to also improve the cleaning of the control element, the control element 1 can be provided with a clear lacquer layer 7.

Another possibility to influence the appearance of the symbol 8 in the control element 1 is to dye the material of the plastic base body 2. This makes it possible to adjust and to display different lighting densities and colorings on the control element 1.

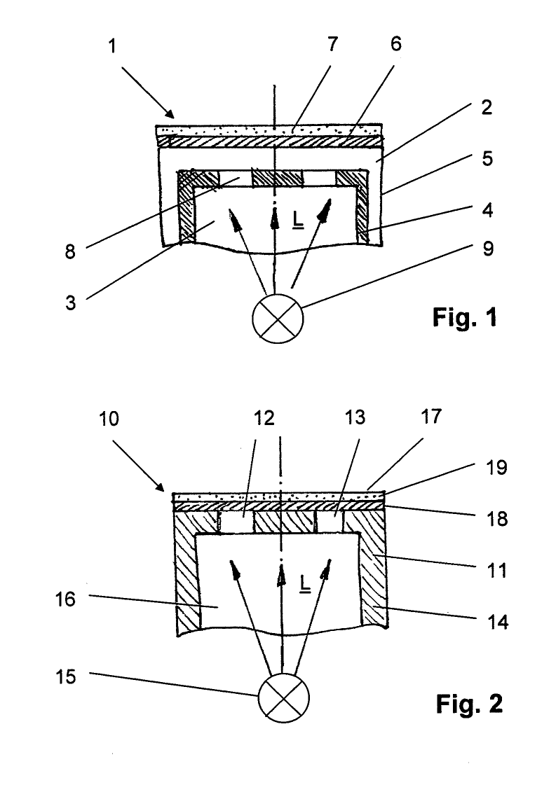

In FIG. 2, there is shown a side view of an alternative embodiment of the invention in a section through a control element 10. The plastic base body 11 can be made from an opaque plastic material that can have, in some regions 12, 13, additional transparent or transparent colored plastic regions 12, 13. This embodiment of a control element of the invention allows for low-cost production since such a plastic base body 11 can be made from opaque regions 14 and transparent regions 12, 13 in one work step and from a single piece. Light L of a lighting device 15 illuminates an inner side 16 of the control element 11 from the back so that the light L passes through the transparent regions 12, 13 and is visible at an upper side 17 of the control element 10.

The control element of the invention as shown in FIG. 2 can include a metallic coating 18 as well as an optional clear lacquer layer 19.

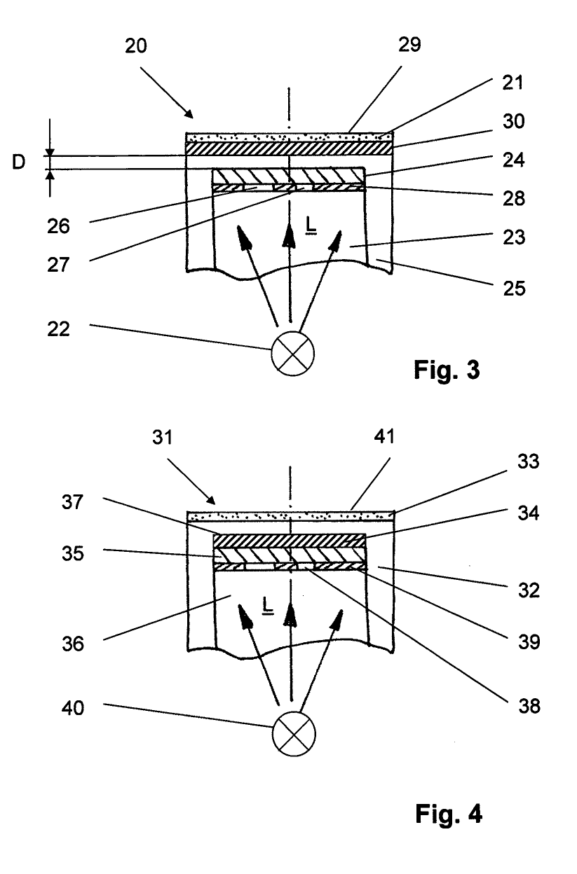

FIG. 3 illustrates a side view of an alternative control element 20 configured in accordance with the invention. There is shown a side sectional view of the control element 20 in a simplified shape with an optional clear lacquer layer 21. In an inner side 23 of the control element 20, which can be illuminated by a lighting device 22 there is inserted a foil 24 that is fastened in the control element 20. The foil is, for example, a foil 24 made from a PC plastic material that is configured to be translucent such as the plastic base body 25. In order for a symbol 26, 27 to be generated on the control element 20 by the light L of the lighting device 22, the foil 24 is printed on one side. The printing may for example be made from an opaque lacquer 28 so that the light L only passes through the region of the symbol 26, 27 and is visible as a symbol 26, 27 on a top side 29 of the control element 20.

The use of a printed foil 24 offers the advantage that this foil 24 can be very easily made in mass production. Moreover, the work step of lacquering the inner side 23 of the control element 20 can be eliminated. The thickness of the foil 24 may hereby range from about 0.05 mm to 2 mm. Depending on the thickness of the foil 24, the foil 24 can be fastened, for example, by glueing and/or clamping, onto an inner side 23 of the control element 20. The foil 24 may thereby also be configured such that the inner side 23 can be completely covered on its entire surface so that the foil 24 can also be configured in the form of a cap or small hat and be fastened in the inner side 23. The thickness D of the transilluminated plastic base body 25 lies between about 0.5 mm and 8 mm and depends on the material chosen for the plastic base body 25.

A metallic coating 30 that can be transilluminated is applied to the plastic base body 25 on an operator side 29 and/or over a portion of or the entire surface on the outer side or sides.

In FIG. 4 there is shown another alternative embodiment of a control element 31 in a sectional side view. The section through the control element 31 can include a button cap as it may be utilized on push buttons for example. The plastic base body 32 can be provided with an optional clear lacquer layer 33. As contrasted with the alternative embodiments of the invention, according to the previously mentioned examples, the continuous metallic coating 34 is applied onto a foil 35. The foil is hereby fastened in an interior 36 of the control element in such a manner that the metallic coating 34 fits against substantially an entire inner surface 37 of the inner side 36 of the control element 31, the inner surface being turned toward the operator. As already described with respect to FIG. 3, the foil 35 is printed with an opaque lacquer 39 on a side turned away from the operator in order to show a symbol 38. As already described above, the foil 35 may be fastened in the control element 31.

In order to display a symbol on the control or display element 31, a lighting device 40 is disposed behind the foil 35 in the control element 31. The light L of the lighting device 40 can hereby only pass through the regions 38 of the lacquer layer 39 that have been laid bare by, for example, a laser beam and can exit at the surface 41 in order to display a symbol.

An advantage of this alternative embodiment is that the coated and lacquered foil 35 may be inserted into the control element 31 in the form of an insert. It is hereby possible to glue the foil 35 into the control element 31 or to insert it into the control element 31, with an air gap being formed thereby. In order to show a metallic optical appearance, a transparent material is used for the plastic base body 32.

The metallic coating 6, 19, 30 of the control elements 1, 10, 20 may, for example, be made from molybdenum (Mo), chromium (Cr) or aluminum (Al). It can be applied by a PVD method, this method for metallic coating by a PVD method being known from prior art such as DE 10 2005 006 459 A1, which corresponds to U.S. Publication No. 20080063836, and which is incorporated herein by reference.

By providing a control element 1, 10, 20 in accordance with the invention there may now be presented a control element 1, 10, 20 that comprises a smooth surface that is not provided with an always visible symbol, pictogram or lettering. The symbol 8, 12, 13, 26, 27 is only visible on the control element 1, 10, 20 by lighting the control element 1, 10, 20 from the back.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A control element comprising:
at least of one plastic base body; and
a metallic coating applied to a surface of the plastic base body and adapted to be transilluminated, the metallic coating being applied by a PVD method,
wherein the metallic coating is applied directly and homogeneously to the plastic base body and has a coating thickness ranging from about 5 nm to about 100 nm.

2. The control element as set forth in claim 1, wherein the plastic base body is formed from an opaque plastic material and in parts from a transparent plastic material.

3. The control element as set forth in claim 1, wherein the opaque plastic material substantially surrounds the transparent plastic material so that a symbol and/or a number and/or a pictogram is shown.

4. The control element as set forth in claim 1, wherein the plastic base body is formed from a clear and/or colored transparent plastic material, wherein the control element is provided on an inner side with an opaque lacquer layer, and wherein a symbol and/or a number and/or a pictogram is provided in the lacquer layer.

5. The control element as set forth in claim 4, wherein the symbol is lasered into the lacquer layer.

6. The control element as set forth in claim 1, wherein a plastic foil is incorporated into an inner side of the plastic base body and wherein the plastic foil comprises opaque regions, in particular lacquered regions, so that a symbol and/or a number and/or a pictogram is provided therein.

7. A control element comprising:
at least one plastic base body;
a metallic coating applied to substantially an entire surface of the plastic base body, the metallic coating adapted to be transilluminated, the metallic coating being generated by a PVD method; and
a plastic foil incorporated onto an inner side of the plastic base body, the metallic coating being applied directly and homogeneously to the plastic foil on a side turned toward an inner surface, the plastic foil comprising opaque regions, in particular lacquered regions, on a side turned away from the inner surface so that a symbol and/or a number and/or a pictogram is shown.

8. The control element as set forth in claim 7, wherein a clear lacquer layer or a colored clear lacquer layer is applied to the surface of the control element that faces an operator.

9. The control element as set forth in claim 7, wherein the control element is backlit.

10. The control element as set forth in claim 7, wherein the plastic base body is made from one piece.

11. The control element as set forth in claim 7, wherein the plastic base body is a panel or a rotary dial or a button in a motor vehicle, in particular a control element of an air-conditioning system.
